(19) United States
(12) Patent Application Publication
(10) Pub. No.: US 2018/0223505 A1
(43) Pub. Date: Aug. 9, 2018

(54) Rainwater Collection and Reuse System (RCRS) and Method

(71) Applicants: Wenbin Yuan, Brookfield, WI (US); Jianzhong Gao, Brookfield, WI (US); Jialuo Gao, Brookfield, WI (US)

(72) Inventors: Wenbin Yuan, Brookfield, WI (US); Jianzhong Gao, Brookfield, WI (US); Jialuo Gao, Brookfield, WI (US)

(21) Appl. No.: 15/424,880

(22) Filed: Feb. 5, 2017

(51) Int. Cl. E03B 3/02; E03F 1/00; E03B 1/04; E04D 13/08; E03F 5/10

(52) U.S. Cl. CPC E03B 3/02; E03F 1/00; C02F 9/00; E04D 13/08; E03F 5/10; E03B 1/04

(57) ABSTRACT

This system uses one or a series of expandable and stackable rectangular boxes designed to collect rainwater from a rooftop or other manmade impervious surface via a downspout to reduce rainwater runoff and harvest rainwater for reuse. The system is comprised of a downspout diverter, one or a series of expandable and stackable rectangular boxes, and pipes. Rainwater is diverted from the downspout into the boxes that are connected by pipes. The collected rainwater exits from a valve leading to an opening for reuse. This opening can also be connected to a pump to raise the water pressure to a higher level for irrigation or other usages. The top of the box consists of a flat surface that is suitable for mounting flower beds or plant containers. The stacked rectangular boxes can also be used as a wall or for other nonintrusive purposes. Our RCRS is easy to install and requires minimal space. Our RCRS is made from cost saving materials. Our RCRS boxes can be easily connected to each other. Our RCRS downspout diverter has self-cleaning capabilities. The flat space located on top of our RCRS boxes can be utilized for plantings such as flower beds or a vegetable garden.

### TECHNICAL FIELD AND BACKGROUND

The present disclosure relates broadly to a system and method for harvesting rainwater for purposes of reuse.

A Rainwater Collection and Reuse System (RCRS) can be utilized in a multitude of ways. For instance, collected rainwater can be stored for later use to irrigate landscapes, crops, or home gardens.

One of the most significant purposes of the RCRS system is to help reduce the surge of storm water inflow into the local municipal treatment system during heavy rainfall periods. These heavy rainfall periods often cause overflow and environmental damage. Damage occurs when the untreated or undertreated combined sewer water is released into the environment that receives treated water. The RCRS can also act as a buffer system to help reduce soil and vegetation erosion. Erosion is often the result of a large runoff in short time frame during a rainfall period. RCRS can be used to reduce the surge of storm water into a more gradual flow utilizing our claimed RCRS applications.

### SUMMARY OF EXEMPLARY EMBODIMENTS

An exemplary embodiments of the present invention is described below. Use of the term “exemplary” means illustrative or by way of example only, and any reference herein to “the invention” is not intended to restrict or limit the invention to exact features or steps of any one or more of the exemplary embodiments disclosed in the present specification. References to “exemplary embodiment,” “one embodiment,” “an embodiment,” “various embodiments,” and the like, may indicate that the embodiment(s) of the invention so described may include a particular feature, structure, or characteristic, but not every embodiment necessarily includes the particular feature, structure, or characteristic. Further, the repeated use of the phrase, “in one embodiment,” or “in an exemplary embodiment,” does not necessarily refer to the same embodiment, although they may.

In an exemplary embodiment, we use one or more rectangular boxes to collect and contain the rainwater. In this exemplary embodiment, there are two boxes. All of the boxes are to be connected together as one system that takes up a minimum amount of space; and offers maximum benefits regarding esthetic values and practical uses for elevated flower bed or vegetation bed, which will be very beneficial for elderly people or handicapped people who cannot bend easily to work on their own home garden. The outlets of the boxes are connected together with pipes to a final downspout pipe. There is a valve on the downspout pipe. To increase the water pressure, a pump can be connected to the downspout pipe. The pump can be concealed in an appropriate box with a cover if desired. The boxes can be stored above-ground or underground. Additional pipes and valves can be added to the outlet of the pump, so that water can be drawn to the appropriate location(s). If the final drainage destination is lower than the outlet, gravity drain can be used.

There is a plank located in the downspout diverter that is connected to it with an axis and a balance mechanism. In this exemplary embodiment, we use a wrench and a balance ball as the balance mechanism. We also can use springs as the balance mechanism. The purpose of the plank is to control the flow of rainwater by allowing it or preventing it from flowing into the downspout diverter's outlet. The plank also functions as a way to aid in cleaning the downspout diverter through adjusting the amount of the water that flows through it.

### BRIEF DESCRIPTION OF THE DRAWINGS

The description of exemplary embodiments proceeds in conjunction with the following drawings, in which:

FIG. 1 is an overview of an exemplary rectangular stackable box adapted for use in a rainwater collection and reuse system (RCRS) and method according to one embodiment of the present disclosure;

FIG. 2 is a box view of the rainwater collection and reuse system. On the top of the container is a cover.

FIG. 3 is a view of the demonstrating attachment and operation of the downspout diverter of the RCRS;

FIG. 4 is one of the situations of the downspout diverter with downspout. This situation is to prevent rainwater from flowing into the downspout diverter's outlet. It includes right side view, sectional view, front view, and oblique view.

FIG. 5 is another situation of the downspout diverter with downspout. This situation is to let rainwater flow into the downspout diverter's outlet. It includes right side view, sectional view, front view, and oblique view.

FIG. 6 is third situation of the downspout diverter with downspout. This situation is to clean the downspout diverter using the rainwater. It include right side view, sectional view, front view, and oblique.

### DESCRIPTION OF EXEMPLARY EMBODIMENTS

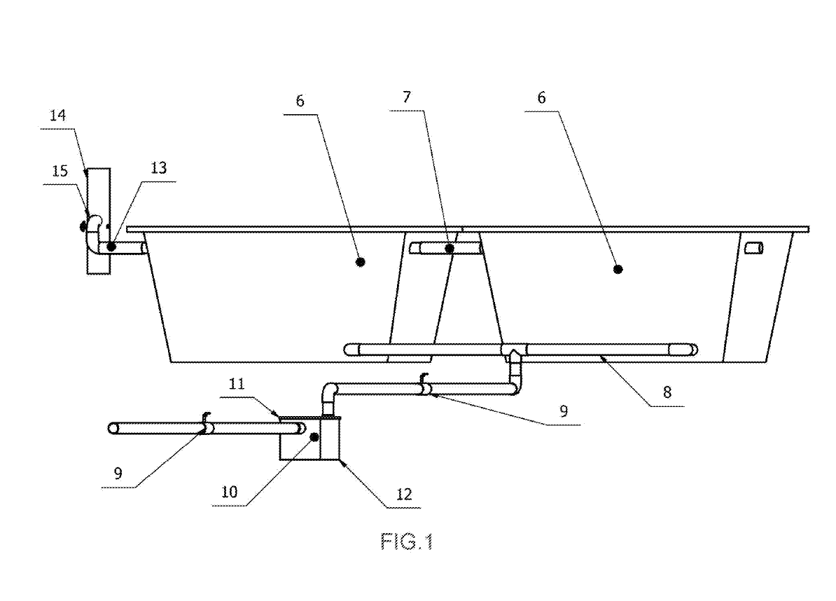

In one embodiment, referring now specifically to the drawings, a system for rainwater collection and reuse is illustrated in FIG. 1. In this exemplary embodiment, there are two boxes (6). The overflow outlet of the first box is connected to the inlet of the second box using pipe (7). The outlets of two boxes are connected together with pipes (8) to a final downspout pipe. There a vale (9) on the downspout pipe. For increase the pressure of the water we also connect a pump (10) to the final pipe. The optional pump is put in an appropriate box (12) with a cover (11). So they can be out on or under the ground. Then we add other pipes and vales on the outlet of the bump. We can draw the overflow to the final locations.

In this exemplary embodiment, there is a downspout diverter (15) extends into a downspout (14). The outlet of the downspout diverter is connected to the inlet of the container box (6) with pipes (13). The rainwater can flow through the pipes into the container box (6).

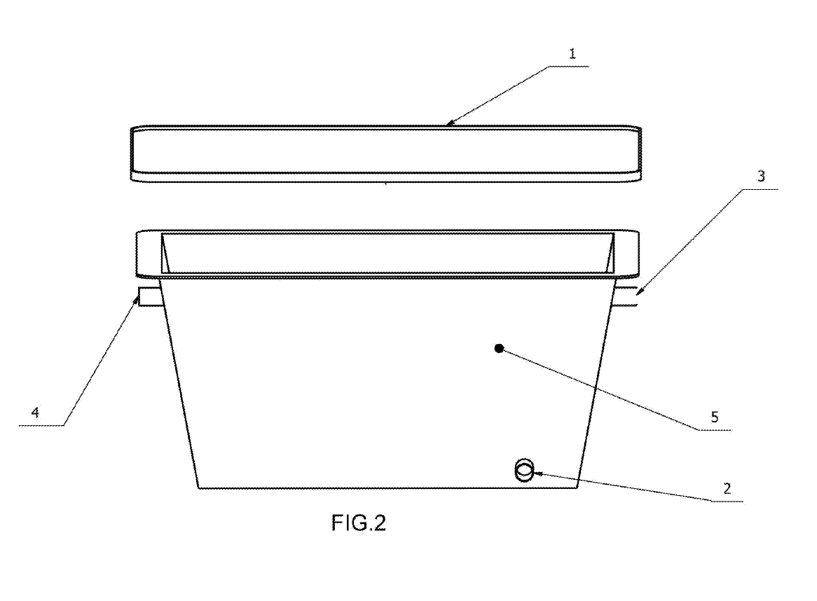

For detailed description, the container box (6), we give the FIG. 2. In FIG. 2, we can see the container (5) has an inlet (4), an outlet (2), an overflow outlet (3), and a cover (1). The cover has a flat surface for future plantation containers to be placed on top, such as flower garden or vegetation beds.

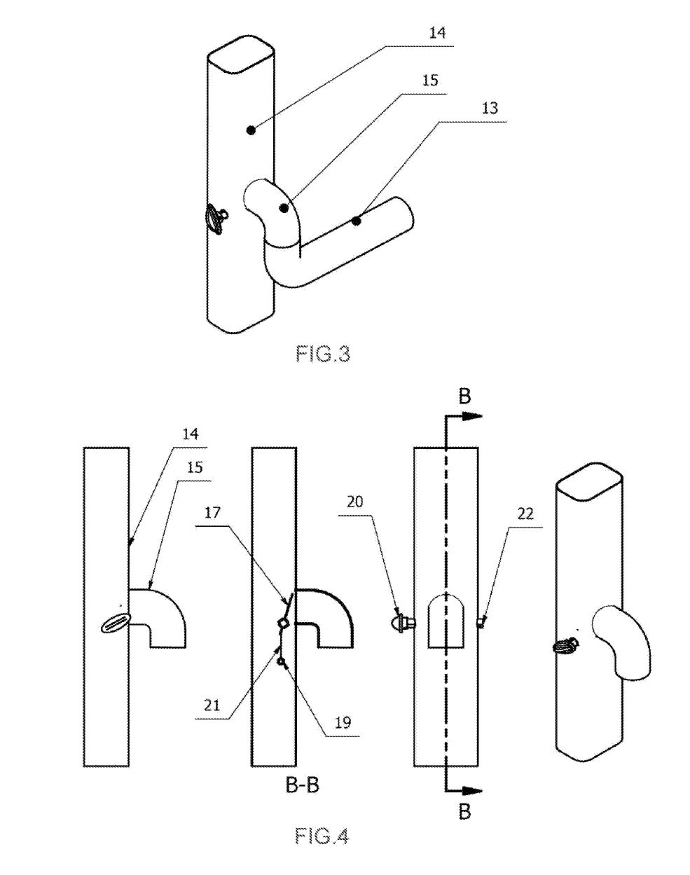

For detailed description how the downspout diverter (15) extends into a downspout (14), we give the FIG. 3. In FIG. 3, we can see how the downspout diverter (15) extends into a downspout (14) and they are connected by pipes (13).

There is a plank (17) in the downspout diverter (15). It is connected to the downspout diverter with an axis (22), a wrench (20) and a balance ball (19) with a string or rope (21).

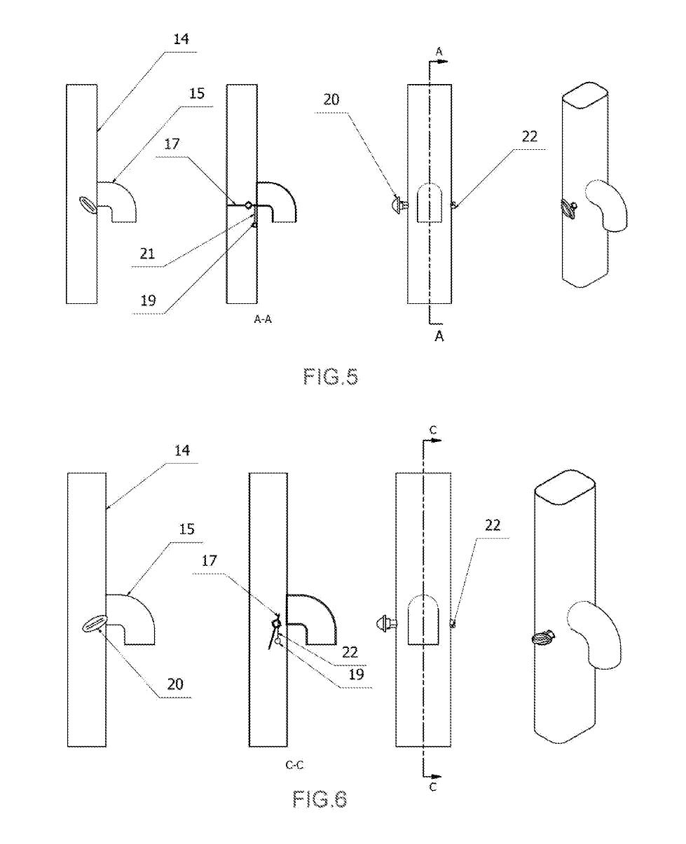

The plank has several functional situations in the downspout diverter. As examples, one situation is to prevent rainwater from flowing into the downspout diverter's outlet (FIG. 4); another situation is to let rainwater flow into the downspout diverter's outlet (FIG. 5); the third situation is to clean the downspout diverter using the rainwater (FIG. 6). In FIG. 4, the plank (17) covers the outlet of the downspout diverter (15), so the rainwater cannot flow into outlet. It is particularly useful in winter. In winter, there is no need to collect rainwater.

In FIG. 5, the plank (17) crosses in the downspout diverter (15), so the rainwater cannot flow down through the downspout. It will flow into the outlet of the downspout diverter (15) then flow into the container boxes (6).

In FIG. 6, the plank (17) parallels in the downspout diverter (15), so the surface of the plank can be cleaned by the rainwater.

In FIG. 5, we give the description of the designs of the balance mechanism of the plank for water distribution inside the downspout pipe. There is an axis (22) in the balance mechanism. It is assembled on the downspout pipe (14). There is a wrench (20) on the axis (22). The plank (17) is fixed on the axis (22) through a bushing. We can use the wrench (20) to change the position of the plank (17) manually. The weight in left side of plank (17) is heavier than that in the right, so we give a balance ball (19) on the right using a string (21) that is fixed on the right of the plank (17). The blank is balanced through this mechanism. In a normal condition, the rain water comes from the downspout pipe to drop on the plank (17), the flow will be directed by the plank to flow out to the downspout of the diverter (See the details in FIG. 5). When there are more leaves on the plank (17) to add the weight on the left, the water flow will be restricted. Because the water on the left of plank is heavier than the water on the right, the balance is tilted to the left. The plank rotates counterclockwise to allow water to flow down and the balance ball to go up. This way the water will be dropped directly to the bottom of the downspout pipe along with the leaves. See the details in FIG. 6. The plank will go back to the horizontal position when the leaves are no longer there to keep the plank down. In the winter, we can manually rotate the wrench clockwise (20) to make the plank from horizontal position to pass the vertical position and touch the wall of the downspout to prevent the water from flowing in to the container (5). See details in the FIG. 4.

We claim:

1. A system for rainwater collection and reuse to contain rainwater, reuse the rainwater and make use the containers' top flat area for plantings and the rectangular boxes to save space. A system to collect and reuse the rainwater that is suitable to include a downspout diverter, one or a series of expandable rectangular and stackable boxes, and pipes. Rainwater will be collected from the downspout to these rectangular boxes that can be connected from pipes in between and eventually exit from a valve to the final opening for reuse. The final opening can also be connected to a pump to raise the water pressure to higher levels for irrigation or other usages. The top of the box consists of a flat surface that is suitable for mounting flower beds or plant containers. The rectangular boxes can be placed next to each other to save space and to look esthetically pleasing as a natural addition to the wall.

2. The system for rainwater collection and reuse according to claim 1, wherein one or a series of rectangular boxes can be put next to each other on the appropriate field or next to an existing wall.

3. The system for rainwater collection and reuse per claim 1, wherein the said system includes: an inlet, a downspout diverter, an outlet, an overflow outlet, and a series of containers with top covers that can be used for future plant beds.

4. The system for rainwater collection and reuse per claim 3, wherein said the inlet can be connected to the downspout diverter, the outlet of other boxes' overflow outlet, or other rainwater sources.

5. The system for rainwater collection and reuse per claim 3, wherein said the outlet can be connected to a pump to raise the water pressure higher levels for irrigation or other usages.

6. The system for rainwater collection and reuse per claim 3, wherein the said overflow outlet can be connected using pipes to draw the outflow to the desired locations.

7. The system for rainwater collection and reuse per claim 3, wherein the said rectangular containers can be different sizes that can match the appropriate background to save space and match existing walls. The system can be painted that will match the surrounding environment to provide esthetic values to rainwater collection and reuse.

8. The system for rainwater collection and reuse per claim 3, wherein the said top covers have flat surfaces for future planting containers to be placed on top, for flower beds or a vegetable garden.

9. The system for rainwater collection and reuse per claim 1, there is a downspout diverter in the system.

10. The system for rainwater collection and reuse per claim 9, where there is a plank in the downspout diverter. The downspout diverter system has an axis and a balance mechanism to be activated by the weight of water column height during the rain. It serves multiple purposes in the downspout diverter. For example, one purpose is to prevent rainwater from flowing into the downspout diverter's outlet which is always closed in winter; one purpose is to let rainwater flow into the downspout diverter's outlet when rainwater is collected in the container(s); and the last purpose is to help clean the downspout diverter using the pressure of the rainwater when the downspout is clogged or when it is necessary by hand.
